(19) United States
(12) Patent Application Publication
(10) Pub. No.: US 2021/0082388 A1
(43) Pub. Date: Mar. 18, 2021

(54) CONTROL DEVICE AND METHOD FOR NOISE REDUCTION OF AUXILIARY ASSEMBLIES FOR A VEHICLE

(71) Applicant: Ipetronik GmbH & Co. KG, Baden-Baden (DE)

(72) Inventors: Thomas HARTMANN, Gaggeneu (DE); Walter ZIPP, Baden-Baden (DE)

(21) Appl. No.: 16/603,204

(22) PCT Filed: Mar. 13, 2018
(86) PCT No.: PCT/EP2018/056161

§ 371 Date: Oct. 4, 2019

(30) Foreign Application Priority Data
Apr. 7, 2017 (DE) 10 2017 107 538.0

(51) Int. Cl. G10K 11/178

(52) U.S. Cl. CPC G10K 11/17881; G10K 11/17857; G10K 2210/129; G10K 2210/1282; G10K 11/17883

(57) ABSTRACT

The invention relates to a control device (1) and to a control method for noise reduction for a vehicle. The control device comprises the following: at least one supported auxiliary assembly for the vehicle, for example an air conditioning system (4) having an air conditioning compressor (40), an electrical accumulator (60) or a range extender (70), wherein the auxiliary assembly emits vibrations in operation; at least one vibration sensor (21a) for detecting vibrations; at least one controllable vibration actuator (22a) for generating vibrations and a control unit (10), which is connected to the vibration sensor and the vibration actuator or the vibration damper, wherein the control unit (10) is designed, based upon the detected vibrations, to generate control signals for transmission to the vibration actuator or the vibration damper (45, 52, 71, 81), which result in the vibrations emitted by the auxiliary assembly being reduced and/or masked in a vehicle interior (3).

### CROSS-REFERENCE TO RELATED APPLICATIONS

This application is a national phase application of international application no. PCT/EP2018/056161, which filed on Mar. 13, 2018, and which claims priority to German application no. 10 2017 107 538.0, which filed on Apr. 7, 2017.

### BACKGROUND

Vehicles produce mechanical vibrations during driving operation in the form of vibrations, which may propagate through the vehicle as structure-borne sound and are emitted as sound in the form of acoustic vibrations. These vibrations and sound in the form of noise or noises may be perceived by humans. The vibro-acoustic behavior of the vehicle is decisive as to whether the vibrations emitted may be perceived by vehicle occupants or persons in the vicinity of the vehicle as disturbing or even harmful to health.

In vehicles driven exclusively by an internal combustion engine, the vibrations generated by the drivetrain are typically dominant. In electric or hybrid vehicles, the drivetrain has an electric motor as a main drive and the noises generated by the drivetrain are typically quieter.

Even when a vehicle is stopped, in particular even when the drive is switched off, vehicles may generate vibrations, which are caused, for example, by auxiliary assemblies of the vehicle. Such auxiliary assemblies are, for example, an air conditioner with an air conditioning compressor or power steering with a hydraulic servo pump.

The air conditioning system in particular, both during operation as a cooling system for cooling as well as during operation as a heat pump for warming the vehicle interior, also in particular during operation as an auxiliary heater or auxiliary chiller, may produce an undesired vibro-acoustic behavior of the vehicle. Undesired vibrations may likewise occur due to the cooling of the electric accumulator of an electric or hybrid vehicle, in particular during a rapid charging process. Excitations of vibro-acoustic effects typically occur due to electrically-driven air conditioning compressors, in particular scroll compressors, and due to other components of the air conditioning system.

The generation of additional external noise to warn other road users in the case of electric or hybrid vehicles in the low speed range, thus in particular in fully electric operation, is known from the prior art.

In addition, technical measures are basically known for conventional vehicles with internal combustion engines, which aim to prevent, mitigate, or compensate for noises generated in the drivetrain.

However, in the case of electric vehicles and hybrid vehicles in fully electric operation, vibro-acoustic noises generated by auxiliary assemblies, in particular by an air conditioning system, are particularly noticeable because masking noises, typically combustion and exhaust noises in conventional vehicles, are omitted.

### SUMMARY

One or more embodiments of the invention are directed to improving the vibro-acoustic behavior of vehicles, in particular of electric vehicles or hybrid vehicles. In particular, the noises emitted by a vehicle should be perceived as less disruptive by occupants of the vehicle and/or persons in the vicinity of the vehicle.

The problem is solved, in particular, by a control device for noise reduction for a vehicle, in particular an electric vehicle or hybrid vehicle, comprising:
at least one mounted auxiliary assembly for the vehicle, for example, an air conditioning system with an air conditioning compressor, an electric accumulator, or a range extender,
wherein the auxiliary assembly emits vibrations during operation;
at least one vibration sensor for detecting vibrations, in particular from sound and/or vibrations;
at least one controllable vibration actuator for generating vibrations, in particular sound and/or vibrations, and/or at least one controllable semi-active vibration damper of the mounting of the auxiliary assembly; and
a control unit, which is connected to the vibration sensor and the vibration actuator or the vibration damper,
wherein the control unit is designed, at least based on the detected vibrations, to generate control signals for transmission to the vibration actuator or the vibration damper, which result in the vibrations emitted by the auxiliary assembly being reduced and/or masked in a vehicle interior and/or in a vehicle surroundings.

According to one or more embodiments of the invention, an auxiliary assembly is understood to be any auxiliary machine of a vehicle, in particular of an automobile; however, not the main drive, thus the main drive motor for propulsion of the vehicle. For example, auxiliary assemblies of a vehicle are an air conditioning system with an air conditioning compressor, power steering, in particular with a hydraulic servo pump, and various pumps or fans. In electric or hybrid vehicles, an auxiliary assembly is, for example, an electric, or electrochemical accumulator or a range extender, in particular with an internal combustion engine, preferably with a connected generator. An electric accumulator may be understood, in particular, to be an accumulator which functions to supply energy to the drivetrain and/or other auxiliary assemblies of an electric or hybrid vehicle.

Microphones, in particular, for detecting sound and/or acceleration sensors for detection vibrations, in particular structure-borne sound sensitive sensors, are provided as vibration sensors. A vibration actuator may be understood according to one or more embodiments of the invention to be speakers and/or active vibration dampers or active vibration absorbers, in particular those based on electrodynamic or gas-dynamic damping principles. A controllable vibration actuator may generate vibrations of an, in particular, variably adjustable amplitude, frequency, and/or phase. Vibrations generated by a vibration actuator may be used for overlapping with vibrations generated by an auxiliary assembly, in particular for destructive interference in an sound field, also designated as “anti-sound” or active noise compensation, for damping or absorbing mechanical vibrations, in order to prevent or to limit their propagation, or to cover or mask sounds for human hearing. A mounting of the auxiliary assembly may have a semi-active vibration damper, which is controllable, in particular to the extent that the spring stiffness characteristic and/or damping characteristic of the mounting is, in particular, variably adjustable, wherein vibrations are passively damped corresponding to the adjusted damping behavior. Thus, at least a partial decoupling of the mounted auxiliary assembly may be achieved so that an introduction of emitted vibrations, in particular into the vehicle chassis, may be prevented or at least reduced.

According to one or more embodiments of the invention, the propagation of mechanical vibrations generated by an auxiliary assembly should be prevented or reduced on the one hand by a control system for semi-active vibration damping, in particular by means of semi-active or intelligent mountings. On the other hand, the perception of the noises occurring due to vibro-acoustic effects should be reduced, in particular locally, by a control system for active noise compensation or noise masking by means of vibration actuators. A reduction of disturbing noises of an auxiliary assembly is thereby selectively or simultaneously achievable for occupants of an interior of a vehicle and/or for persons in the vicinity of a vehicle. The control system is designed, in particular, to prioritize a reduction or masking for the vehicle interior or the vehicle surroundings based on detected or transmitted data and/or to maintain prespecified limit values for noise emission or noise immission.

The vibro-acoustic behavior is improved based on the control device according to one or more embodiments the invention. In particular, unfamiliar or disturbing noises of an auxiliary assembly of a vehicle are reduced in their effect. In particular, an electric vehicle or a hybrid vehicle is thus quieter in fully electric operation, in particular when the vehicle is stopped and an auxiliary assembly is simultaneously operated.

In one advantageous refinement of one or more embodiments of the invention, a vibration sensor is an interior microphone for detecting sound in a vehicle interior, said interior microphone being arranged, in particular, at a headrest of a vehicle seat, or an exterior microphone for detecting ambient noises. An interior microphone is integrated, in particular, into the headrest, wherein a separate interior microphone may be provided for each headrest. Thus, sound in the vicinity of the hearing of the occupants may be detected and vibration actuators, in particular, speakers or active vibration dampers in the vehicle interior, like shakers, may be controlled so that an active noise compensation is achieved. For example, the seat position of a vehicle seat might be detected by sensors and flow into the control system in order to achieve a more targeted control result. An interior microphone may, however, also be the microphone of a hands-free system. An exterior microphone may, for example, be provided for attachment underneath the engine hood or on the exterior of a vehicle, and may detect, in particular, traffic noise, construction noise, wind noises, rain noises, or noises from passers-by.

In one advantageous refinement of one or more embodiments of the invention, the control device comprises at least one camera, in particular for detecting the position of a vehicle seat and/or the head position of an occupant of the vehicle, and/or for detecting the drowsiness of an occupant of the vehicle. At least one camera, in particular a stereo camera, is preferably arranged in the vehicle interior, preferably in the area of a sun visor, and oriented at the vehicle seat or the head of an occupant. Using a camera, the drowsiness of an occupant might be detected via suitable image recognition methods, in particular for face recognition and eye detection, in that it is detected whether the eyes of an occupant are open or closed. An active noise compensation in the vehicle interior might then be optimized for a resting vehicle occupant. In particular, buzzing tones may be very differently expressed at different seat positions, and, e.g., vary by 6-8 dB per 40 cm or position change in the transverse direction of the vehicle. In particular, a changed position of the head of the vehicle occupant results in the case of a vehicle seat, whose seatback is folded back into a lying position. A camera has the advantage that, with the aid of an image recognition method, the position of the seat, in particular of the headrest or the head of the driver, particularly the driver's ears, are precisely detectable and a target range for the optimization of an active noise compensation, in particular by means of destructive interference, may be identified by suitable image recognition methods. Thus, the control result may be further improved with respect to an active noise compensation in the vehicle interior, in particular for a resting vehicle occupant.

In one advantageous refinement of one or more embodiments of the invention, a vibration actuator is an interior speaker oriented at a vehicle interior, or an exterior speaker oriented at a vehicle surroundings, in particular to emit anti-sound and/or masking sound. By controlling speakers using control signals, tuned by the control unit to the acoustic signals detected by microphones, a destructive interference may be achieved in the sound field, in particular locally, in the vicinity of a microphone. A hifi interior speaker of an on-board audio entertainment system may also be used as the interior speaker. An exterior speaker may be provided, for example, for applying underneath the vehicle hood or on the exterior of a vehicle. Sounds for covering disturbing noises of the auxiliary assembly may be played into the vicinity of a vehicle via an exterior speaker.

In one advantageous refinement of one or more embodiments of the invention, the auxiliary assembly comprises an air conditioning compressor, in particular a scroll compressor, or a range extender, which has a rotational speed sensor, wherein the control unit is designed, based on a rotational speed of the air conditioning compressor or of the range extender, detected by the rotational speed sensor, to generate control signals in particular to adjust, preferably variably, the spring stiffness and/or damping of the semi-active vibration damper. An air conditioning system comprises, for example, an air conditioning compressor, for example in the form of a scroll compressor or a swash plate compressor, which may generate mechanical vibrations depending on its rotational speed and/or load, and may thus cause vibro-acoustic effects in a vehicle. Rotational speed dependent vibrations may also occur in the case of a range extender with an internal combustion engine as an auxiliary assembly, in particular with a generator connected via a rotating shaft. Because the rotational speed of such an auxiliary assembly is detected by sensors, the rotational speed may flow into the control system as a parameter. A rotational speed dependent model, for example, in the form of a table, of the vibro-acoustic behavior of the auxiliary assembly, in particular of the air conditioning system with the air conditioning compressor and other components, for example, the condenser, the evaporator, or the coolant lines, or the range extender with the internal combustion engine, and/or a rotational speed dependent characteristic curve of the mounting of the auxiliary assembly, in particular with respect to its spring characteristics and/or damping characteristics, is stored, in particular, in the control unit. In this way, the control system may adjust the mounting characteristic depending on the detected rotational speed, in particular variably over time, in order to achieve the desired passive damping characteristics of the mounting. Vibrations generated by the auxiliary assembly are detectable most effectively, namely already in the vicinity of the sound source, via vibration sensors, for example microphones or structure-borne sound sensors, in particular acceleration sensors, arranged, in particular, in the vicinity of the auxiliary assembly. Using such a control device, at least a partial decoupling may be achieved of the auxiliary assembly from a vehicle chassis, so that the introduction of structure-borne sound is prevented or reduced. In this way, the vibro-acoustic behavior of the vehicle may be further improved in the case of an operating auxiliary assembly, in particular in the case of a stopped vehicle, even in the case that the main drive is switched off.

In one advantageous refinement of one or more embodiments of the invention, the semi-active vibration damper comprises a magnetorheological or an electrorheological material, in particular a fluid, a gel, an elastomer, or a foam. The spring stiffness characteristic and the damping characteristic of mountings, which are based on magnetorheological or electrorheological materials, in particular fluids (MRF, ERF) or elastomers (MRE, ERE), are controllable, in particular controllable depending on rotational speed in order to achieve a decoupling of the mounted auxiliary assembly to prevent vibro-acoustic effects. It is also conceivable to use piezo ceramic materials in semi-active mountings for auxiliary assemblies.

In one advantageous refinement of one or more embodiments of the invention, a vibration actuator is an active pulsation damper, which is arranged, in particular in a coolant line of an air conditioning system. Active pulsation dampers comprise, in particular, an actively controllable gas volume, separated by means of a membrane, in order to damp flow-dynamic vibrations. Active pulsation dampers are arranged, in particular, in the suction line and/or hot gas line of the air conditioning system, in particular, in a supply line and/or drainage line of the air conditioning compressor.

In one advantageous refinement of one or more embodiments of the invention, the vibration actuator is a single-axis or multi-axis shaker, in particular for arrangement on a roof, a floor panel, or a steering column of the vehicle. Active electro-dynamic vibration dampers, like shakers, are provided in particular for application on at least one point of the vehicle chassis in order to damp or to cancel out mechanical vibrations.

In one advantageous refinement of one or more embodiments of the invention, the vibration sensor is an acceleration sensor for detecting vibrations, in particular for arrangement on a vehicle chassis. At least one structure-borne sound sensitive acceleration sensor is preferably assigned to the vehicle interior. Additional acceleration sensors may be provided in the area of auxiliary assemblies, e.g., in the area of an air conditioning system in the front area of a vehicle, or in the area of a range extender in the rear area of a vehicle. Structure-borne sound signals detected at corresponding positions by acceleration sensors may flow into the control system.

In one advantageous refinement of one or more embodiments of the invention, the control device has a transmission/receiving unit, which is designed to receive noise emission and/or noise immission limit value data, wherein the control device preferably has a GPS receiver, and the transmission/receiving unit is preferably designed to receive noise emission and/or noise immission limit value data based on a position and/or time received from the GPS receiver. Noise emission and/or noise immission limit value data, in particular legally required limit values, may, for example, be transmitted to the control device by an external database, e.g., of an environmental agency, or by a charging station for an electric vehicle, via, e.g., a radio connection, or may be transmitted locationally and chronologically specifically, at the request of the control device, based on a detected vehicle position and/or a time, in particular the clock time and/or the date. Noise emission and/or noise immission limit value data may relate, for example, to, e.g., a residential area, a spa area, or an industrial area, in which a vehicle is currently located, or to a weekday, a holiday, night time, business hours, during which a vehicle is currently traveling. In this way, the control system may be designed so that the limit values may be maintained for the noise emissions of the vehicle or noise immission for occupants and/or persons in the vehicle surroundings.

In particular, the control device comprises a computer-readable, on-board data memory for ambient acoustic data of the vehicle and/or vehicle emission and/or vehicle immission limit value data, which relate in particular to a vehicle surroundings.

The problem is additionally solved in particular by a vehicle, in particular an electric vehicle or hybrid vehicle, which has a control device according to one or more embodiments of the invention as previously described.

The problem is additionally solved in particular by a control method for noise reduction for a vehicle, which is carried out in particular by means of a device according to one or more embodiments of the invention, wherein the control method comprises the following steps:
detecting vibrations, in particular of sound and/or vibrations which are emitted by an auxiliary assembly of the vehicle, by means of at least one vibration sensor;
generating control signals, based at least upon the detected vibration, by means of a control unit;
transmitting the control signals to at least one controllable vibration actuator and/or at least one controllable semi-active vibration damper of the mounting of the auxiliary assembly;
generating vibrations, in particular sound and/or vibrations by means of the vibration actuator, and/or damping vibrations by means of the vibration damper, based on the transmitted control signals, which results in that the vibrations emitted by the auxiliary assembly are reduced and/or masked in a vehicle interior and/or in a vehicle surroundings.

The method has similar advantages, as were already described in connection to the control device according to one or more embodiments of the invention. The method may be implemented by the control device according to one or more embodiments of the invention, in particular by such a control device in a vehicle. The method may further comprise some or all of the technical features that are described in conjunction with the control device.

In one advantageous refinement of one or more embodiments of the invention, the control method is carried out when the vehicle, in particular an electric vehicle or hybrid vehicle, is stopped yet the auxiliary assembly is operating, preferably during operation of an air conditioning system or auxiliary heater and/or during charging the electric accumulator of the vehicle, in particular during a fast charging process of the electric accumulator. The vibrations emitted during operation of auxiliary assemblies when the vehicle is stopped may be reduced and/or masked by the control method according to one or more embodiments of the invention, while the noise from the main drive, in particular an internal combustion engine or an electric motor, are quieter than during driving operation or are wholly omitted when the vehicle is stopped. In particular, the control method is carried out when the main drive is idling or is temporarily switched off due to an automatic engine start-stop, e.g., when the vehicle is stopped at a red light or in traffic congestion. However, the method is also preferably carried out when the main drive is completely switched off, e.g., during a charging process of the electric accumulator of an electric of hybrid vehicle. In this way, noises from auxiliary assemblies, which would not be disturbing or noticeable during the circumstances of driving operation, are reduced and/or masked.

In one advantageous refinement of one or more embodiments of the invention, the control method comprises detecting the, in particular variable, rotational speed of an air conditioning compressor comprised by an auxiliary assembly, in particular of a scroll compressor of an air conditioning system, or a range extender, and the generation of control signals, based on the detected rotational speed, in particular for adjusting, preferably variably, the spring stiffness and/or damping of the semi-active vibration dampers of the mounting of the auxiliary assembly.

In one advantageous refinement of one or more embodiments of the invention, the control method comprises detecting the ambient noise of the vehicle by means of an exterior microphone, and, in particular, the storing of the detected ambient acoustic data in a computer-readable, on-board data memory, preferably in the form of recorded reference acoustic signals.

In one advantageous refinement of the invention, the control method comprises the receiving of noise emission and/or noise immission limit value data, for example, from a charging station for an electric vehicle or hybrid vehicle, or based on received GPS data, wherein the noise emission and/or noise immission limit value data relate, in particular, to a vehicle surroundings.

In one advantageous refinement of the invention, the control method comprises adjusting, in particular variably, of the charging power of the electric accumulator of the vehicle during the charging process, in particular based on the cooling output of an air conditioning system required for cooling the electric accumulator during the charging process, in such a way that noise emission and/or noise immission limit values are maintained. In particular, the control method comprises adjusting, in particular variably, the rotational speed and/or the load of an air conditioning compressor of an air conditioning system in such a way that noise emission and/or noise immission limit values are maintained.

In one advantageous refinement of one or more embodiments of the invention, the control method comprises emitting sound into the vehicle surroundings by means of at least one exterior speaker to mask the sound emitted by an auxiliary assembly, in particular based on read-out surroundings acoustic data, in particular, recorded reference acoustic signals, preferably in chronologically irregular intervals. During a masking interval, the rotational speed in particular, of an auxiliary assembly, in particular of an air conditioning compressor, may be increased, wherein the noises from the auxiliary assembly are covered or deflected by the masking noise. The emitted sound may comprise, for example, tones, static, music, surroundings noises, like traffic noise, construction noise, wind noises, noises from passing vehicle or passing passers-by, or birdsong.

In one advantageous refinement of one or more embodiments of the invention, the control method comprises prioritizing the generation of control signals which essentially affect either a vehicle interior or a vehicle surroundings, in particular based on a seat occupancy of the vehicle detected by sensors and/or detected surroundings data of the vehicle. The vehicle position and/or an instantaneous time may also be considered. For example, a control step, which targets noise reduction in the vehicle interior, may be omitted if no occupants are located in the vehicle. Under circumstances, a control step, which targets noise reduction and/or masking in the vehicle surroundings, may then be carried out even more effectively or while conserving more resources.

In addition, according to one aspect of one or more embodiments of the invention, the control method may comprise detecting of vibrations of a cooling system of a charging station for an electric accumulator and taking the detected vibrations into consideration in the control method, in particular if an auxiliary assembly of the vehicle is not operating during a charging process of the electric accumulator. In this way, noises emitted in particular by the charging station may be reduced and/or masked by the control device or control method according to one or more embodiments of the invention in a vicinity of the vehicle.

### BRIEF DESCRIPTION OF THE DRAWINGS

Exemplary embodiments of the invention are subsequently described by way of the drawings.

FIG. 1 shows a schematic depiction of a vehicle with a control device according to one or more embodiments of the invention; and

FIG. 2 shows a schematic depiction of a control device according to one or more embodiments of the invention.

### DETAILED DESCRIPTION

In the subsequent description of one or more embodiments of the invention, the same reference numerals are used for identical and identically acting elements.

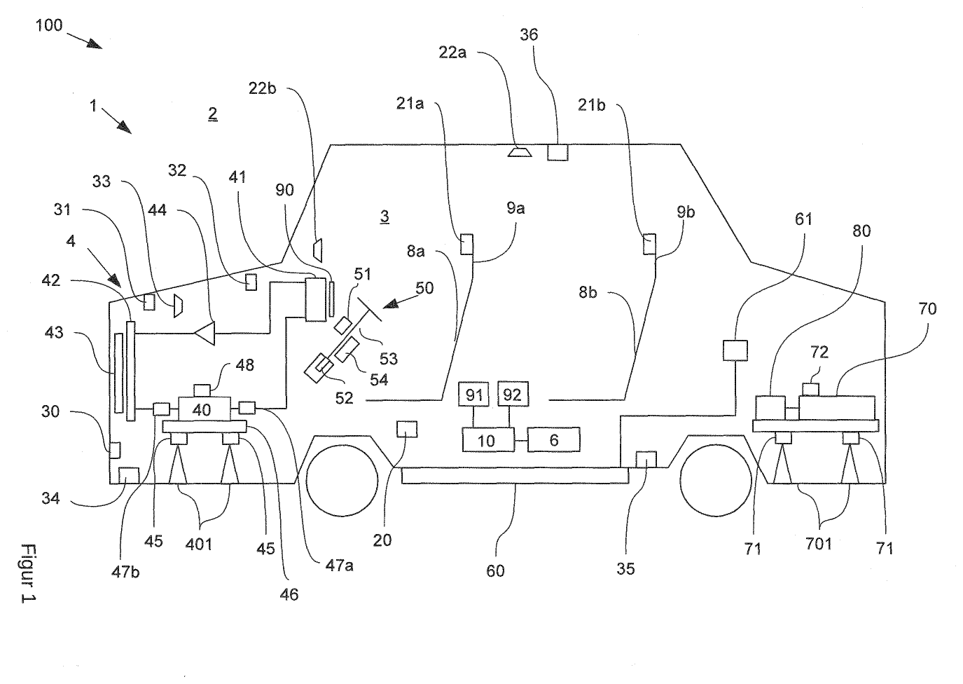

FIG. 1 shows a vehicle 100 according to one or more embodiments of the invention, in this case an electric or hybrid vehicle, having a control device 1 according to one or more embodiments of the invention, wherein vehicle 100 has different auxiliary assemblies, like an air conditioning system 4, power steering 50, and an electric accumulator 60. Electric accumulator 60 functions for the power supply for the drivetrain and/or other auxiliary assemblies of vehicle 100. Additionally, a range extender 70 is optionally provided, which is designed in this case as an auxiliary assembly with an internal combustion engine, to which a generator 80 is coupled. Air conditioning system comprises an air conditioning compressor 40, in particular a scroll compressor, an evaporator 41, a condenser 42, a fan 43, and expansion valve 43, and connecting coolant lines. Air conditioning system 4 may be used for heating or cooling of vehicle interior 3, and for cooling electric accumulator 60, in particular during charging. Air conditioning compress 40 is mounted via semi-active vibration damper 45 of mounting 401 on a subframe 46, which is, e.g., approximately double the length and width of air conditioning compressor 40. Likewise, range extender 70 and generator 80 are mounted via semi-active vibration damper 71 of mounting 701 on the vehicle chassis. A mutual mounting with additional components of air conditioning system 4, e.g., evaporator 41 and condenser 42, or individual mountings may respectively be provided. This likewise applies for range extender 70 and generator 80, and potential additional elements peripheral to the drive. Power steering 50 provided in the area of steering column 53 comprises a servo pump 50. Auxiliary assemblies, like air conditioning system 4 with air conditioning compressor 40, power steering 50 with servo pump 52, electric accumulator 60, range extender 70, and generator 80 generate vibrations during operation, which may cause vibro-acoustic effects, which may be perceived as disturbing by occupants of vehicle 100 in vehicle interior 3, or by persons in vehicle surroundings 2, thus outside of vehicle 100.

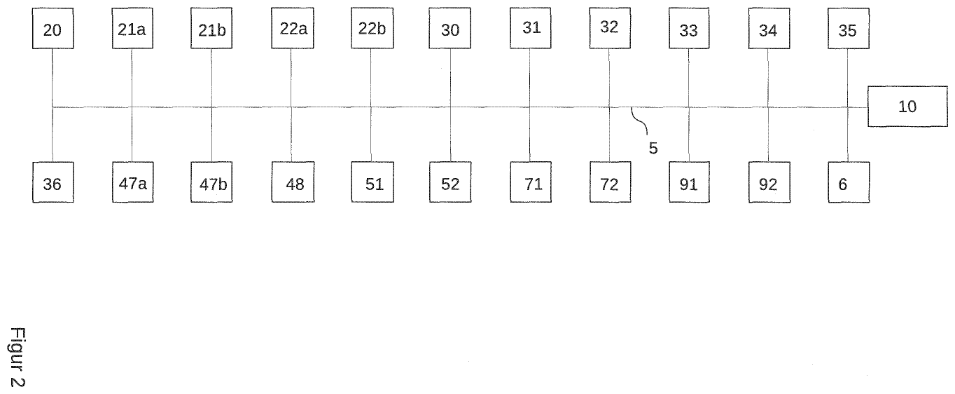

According to one or more embodiments of the invention, control device 1 depicted in FIGS. 1 and 2 comprises, in addition to the listed auxiliary assemblies, a control unit 10, which has at least one processing unit in particular a CPU, and vibration sensors 21a, 21b, 32, 20, 30, 31, 52 and controllable vibration actuators 22a, 22b, 33, 34, 35, 36, 51, 47a, 47b, and listed controllable, semi-active vibration dampers 45, 71, which are all connected to each other communicatively or in a signal-conducting manner via vehicle data bus 5 (see FIG. 2). In addition, control devices (not depicted) are provided, assigned to the vibration sensors and to the vibration actuators. In addition, control device 1 comprises an on-board vehicle memory 6, a transmission/receiving unit 91, and a GPS receiver 92, which are all connected to control unit 10 via vehicle data bus 5. Control unit 10 executes a control algorithm, stored on a computer-readable memory, whose input parameters are based on sensor signals generated by vibration sensors 21a, 21b, 32, 20, 30, 31, 52 and whose output parameters are transmitted as control signals to vibration actuators 22a, 22b, 33, 34, 35, 36, 51, 47a, 47b and/or semi-active vibration dampers 45, 71. However, only some of the listed vibration sensors, vibration actuators or vibration dampers and subgroups of the same may also be provided in control device 1. In particular, embodiments of the invention are included, which have only some of the listed auxiliary assemblies, in particular only air conditioning system 4, power steering 50, electric accumulator 60 or range extender 70, and any combination thereof.

According to one aspect of one or more embodiments of the invention, vibration sensors are arranged as first and second interior microphones 21a or 21b on headrests 9a or 9b of vehicle seats 8a or 8b, which detect sound in vehicle interior 3 and transmit corresponding sensor signals to control unit 10. In addition, vibration actuators are aligned with the vehicle interior as interior speaker 22a and/or hifi interior speaker 22b, which emit sound into the vehicle interior, based on control signals generated by the control unit, in order to generate a sound field within the vehicle interior with, at least locally, destructive interference. By feeding the sensor signals detected by interior microphones 21a and 21b back to the control unit, interior speakers 22a and/or 22b may be controlled so that sound is cancelled out or at least minimized in a targeted way in the area of headrests 9a and 9b. In particular a targeted wave field synthesis may be created in vehicle interior 3 via multiple interior speakers. Masking sound may also be emitted via interior speakers 22a, 22b in order to cover vibrations emitted by an auxiliary assembly.

According to another aspect of one or more embodiments of the invention, a vibration sensor is provided as an exterior microphone 32 and a vibration actuator as an exterior speaker 33 oriented at vehicle surroundings 2. Multiple exterior microphones 32 and/or exterior speakers 33 may be provided at different points of the vehicle or at different orientations. Surroundings noises, for example, of vehicle 100 may be detected via exterior microphone 32 and stored in an on-board data memory 6, preferably after a data processing step. Similar to how this was described in conjunction with the vehicle interior, destructive interference may be also generated in the sound field in the vehicle surroundings via exterior speaker 33, in particular by emitting anti-sound. Alternatively or additionally, noises from auxiliary assemblies may be masked, for example, by playing back surroundings noise previously recorded as reference acoustic signals and stored in on-board data memory 6, like traffic noise, construction noise, wind noises, rain noises, birdsong and other noises that occur in the vicinity of the vehicle.

According to another aspect of one or more embodiments of the invention, vibration sensors are provided as a structure-borne sound sensitive acceleration sensor 20 assigned to the vehicle interior and additional acceleration sensors 30, 31 in the front area of the vehicle and an acceleration sensor 52 assigned to steering column 53, in order to detect vibrations in the form of structure-borne sound and to transmit or feed corresponding sensor signals back to control unit 10. Electrodynamic vibration actuators in the form on single-axis or multi- axis shakers, namely a shaker 36 applied on the roof, a shaker 35 applied on the floor panel, a shaker 34 applied in the front area of vehicle 100, and a shaker 51 arranged on steering column 53, generate, based on control signals generated by control unit 10, active mechanical vibrations for damping or cancelling out vibrations generated by an auxiliary assembly, for example, by air conditioning compressor 40 or servo pump 54. In this way, undesirable, perceptible vibrations and audible vibro-acoustic effects may be prevented or at least reduced.

According to another aspect of one or more embodiments of the invention, air conditioning compressor 40 and/or range extender 70 are equipped with a rotational speed sensor 48 or 72. By detecting the rotational speed of an auxiliary assembly, the spring stiffness characteristic and/or damping characteristic of the mounting of this auxiliary assembly may be adjusted or controlled depending on the rotational speed via semi-active vibration dampers, so that the auxiliary assembly is decoupled as well as possible from the vehicle chassis, on which it is mounted, in particular for different operating states of the auxiliary assembly. The semi-active vibration dampers comprise, for example, magnetorheological or electrorheological materials, whose spring stiffness characteristics and damping characteristics are magnetically or electrically controllable. Alternatively or additionally, active pulsation dampers 47a, and 47b are provided in coolant lines of air conditioning system 4, and which may be arranged in this case in the supply line or drain line of air conditioning compressor 40, and may damp flow-dynamically generated vibrations based on control signals transmitted by control unit 10.

Control device 1 may receive noise emission and/or noise immission limit value data via transmission/receiving unit 91, which data are queried by control device 1 from an external database, for example, based on a position signal and/or time signal received from a GPS receiver 92 for vehicle 100 via a radio connection. In particular, noise emission and/or noise immission limit value data may be transmitted by a charging station for electric accumulator 60 to control device 1 via transmission/receiving unit 91. The limit values contained in the noise emission and/or noise immission limit value data are taken into consideration by control unit 10 during control steps, insofar as these noise limit values are maintained, for example, in vehicle interior 3 and/or in vehicle surroundings 2. The rotational speed and/or load of air conditioning compressor 40 or of range extender 70 is preferably controlled based on the prespecified noise emission and/or noise immission limit values.

The control method according to the invention is preferably carried out when vehicle 100 is stopped, yet an auxiliary assembly is operated, in particular when air conditioning system 4 is operated. A few examples for applications of the control method are subsequently described.

For example, in a fully occupied vehicle in summer waiting at a red light, the cooling requirements for vehicle interior 3 are high, so that air conditioning system 4 operates air conditioning compressor 40 with a high rotational speed. To minimize vibrations and humming noises in vehicle interior 3, the spring stiffness and damping of mounting 401 is adjusted by control unit 10 depending on the rotational speed via suitable control of semi-active vibration damper 45. Based on noises detected by interior microphones 21a and 21b, the characteristics of the mounting may be readjusted to further reduce the effects of the vibro-acoustic effects.

For example, in a vehicle, which is parked in summer on an unshaded parking lot while the driver would like to sleep with air conditioning system 4 switched on, a low blower level of interior fan 90 is set and air conditioning compressor 40 is operated at high rotational speed in order to provide sufficient cooling. Described control device 1 or the control method according to the invention provides a sufficiently quiet vehicle interior 3. In this case, a seat position, detected by sensors, in particular a lying position of vehicle seat 8a, 8b, may additionally be taken into consideration by the control system in order to locally achieve a more targeted control result. The seat position may be detected, for example, by at least one camera oriented at vehicle seat 8a, 8b, preferably at headrest 9a, 9b, or angle sensors for detecting the position of the backrest.

According to the control method according to one or more embodiments of the invention, a prioritization of control goals may be carried out, which target either vehicle interior 3 or vehicle surroundings 2. For example, in one scenario, electric accumulator 60 of an electric or hybrid vehicle 100 is charged via charging terminal 61 during a short driving interruption for further travel at a fast charging station, which is located, for example, in the vicinity of a street café. Based on the high cooling requirements of electric accumulator 60 and the power electronics during the charging process, a high rotational speed of air conditioning compressor 40 is necessary. The seat occupation, in particular, of vehicle 100 may be detected by sensor. In the case that the vehicle is empty, for example, because the driver of the vehicle waits in the street café during the charging process, a control goal intended for vehicle surroundings 2 may be prioritized instead of a control goal in favor of vehicle interior 3. Due to a very softly adjusted mounting 401 of air conditioning compressor 40, i.e., a low spring stiffness of semi-active vibration damper 45, a humming noise may be generated in vehicle interior 3 on the one hand, and high-frequency vibrations of air conditioning system 4 may be emitted into vehicle surroundings 2 on the other hand. If the vehicle is empty, by prioritizing the control goal by control unit 10, the humming noise is accepted in vehicle interior 3 in order to achieve a noise reduction in vehicle surroundings 2. Simultaneously, low-frequency vibrations based on exterior noise detected by exterior microphone 32 may be emitted into vehicle surroundings 2 via a tuned control of semi-active vibration damper 45 and/or active pulsation damper 47a, 47b.

Additionally advantageous embodiments arise by way of the subclaims. Reference is made at this point to the fact that all aspects of the invention mentioned above are claimed as essentially for the invention when considered alone and in any combination, in particular the details depicted in the drawings. The same applies for the method steps described in greater detail. Alterations form this are familiar to the person skilled in the art.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

### LIST OF REFERENCE NUMERALS

1 Control device
2 Vehicle surroundings
3 Vehicle interior
4 Air conditioning system
5 Vehicle data bus
6 Vehicle data memory
8a Vehicle seat
8b Vehicle seat
9a Headrest
9b Headrest
10 Control unit
20 Acceleration sensor
21a First interior microphone
21b Second interior microphone
22a Interior speaker
22b Hifi interior speaker
30 Acceleration sensor
31 Acceleration sensor
32 Exterior microphone
33 Exterior speaker
34 Shaker
35 Shaker
36 Shaker
40 Air conditioning compressor
41 Evaporator
42 Condenser
43 Fan
44 Expansion valve
45 Vibration damper
46 Subframe
47a Active pulsation damper
47b Active pulsation damper
48 Rotational speed sensor
401 Mounting
50 Power steering
51 Shaker on the steering column
52 Acceleration sensor
53 Steering column
54 Servo pump
60 Electric accumulator
61 Charging terminal
70 Range extender
71 Vibration damper
72 Rotational speed sensor
701 Mounting
80 Generator
90 Interior fan
91 Transmission/receiving unit
92 GPS receiver
100 Vehicle

1. A control device for noise reduction for a vehicle selected from a group consisting of an electric vehicle and a hybrid vehicle, comprising:
at least one mounted auxiliary assembly for the vehicle, wherein the auxiliary assembly emits vibrations during operation;
at least one vibration sensor configured to detect vibrations;
at least one control unit configured to generate control signals based on the detected vibrations; and
at least one controllable vibration actuator configured to generate vibrations based on the control signals and/or at least one controllable semi-active vibration damper of the mounting of the auxiliary assembly configured to damp vibrations based on the control signals to reduce and/or mask vibrations emitted by the auxiliary assembly in an interior of the vehicle and/or in a surroundings of the vehicle.

2. The control device according to claim 1, wherein the a vibration sensor is an interior microphone arranged on a headrest of a vehicle seat for detecting sound in the interior of the vehicle or is an exterior microphone for detecting ambient noises.

3. The control device according to claim 2, wherein the vibration actuator is an interior speaker oriented at the interior of the vehicle, or is an exterior speaker oriented at the surroundings of the vehicle, and wherein the vibration actuator emits anti-sound and/or masks sound.

4. The control device according to claim 1, wherein:
the auxiliary assembly comprises a scroll compressor or a range extender;
the auxiliary assembly is associated with a rotational speed sensor; and
the control unit is configured to, based on a rotational speed of the scroll compressor or of the range extender detected by the rotational speed sensor, generate control signals to variably adjust the spring stiffness and/or damping of the semi-active vibration damper.

5. The control device according to claim 1, wherein the semi-active vibration damper comprises a magnetorheological or an electrorheological material comprising a fluid, a gel, an elastomer, or a foam.

6. The control device according to claim 1, wherein the vibration actuator is an active pulsation damper arranged in a coolant line of an air conditioning system.

7. The control device according to claim 1, wherein the vibration actuator is a single-axis or multi-axis shaker for arrangement on at least one selected from a group consisting of a roof, a floor panel, and a steering column of the vehicle.

8. The control device according to claim 1, wherein the vibration sensor is an acceleration sensor for arrangement on a vehicle chassis.

9. The control device according to claim 1, wherein the control device comprises:
a GPS receiver; and
a transmission/receiving unit configured to receive noise emission and/or noise immission limit value data based on a position and/or a time received by the GPS receiver.

10. The control device according to claim 1, wherein the control device comprises a computer-readable on-board data memory with ambient acoustic data of the vehicle and/or noise emission and/or noise immission limit value data related to the surroundings of the vehicle.

11. An electric vehicle or hybrid vehicle comprising the control device according to claim 1.

12. A control method for noise reduction for a vehicle, comprising:
detecting vibrations emitted by an auxiliary assembly of the vehicle using at least one vibration sensor;
generating control signals using a control unit (10) based at least on the detected vibrations;
transmitting the control signals to at least one controllable vibration actuator and/or at least one controllable semi-active vibration damper of the mounting of the auxiliary assembly; and
generating vibrations using the vibration actuator and/or damping vibrations using the vibration damper, based on the transmitted control signals, in order to reduce and/or mask the vibrations emitted by the auxiliary assembly in an interior of the vehicle and/or in a surroundings of the vehicle.

13. The control method according to claim 12, wherein the control method is carried out when the vehicle is stopped during operation of the auxiliary assembly.

14. The control method according to claim 12, further comprising:
detecting a rotational speed of a scroll compressor in the auxiliary assembly and associated with an air conditioning system or a range extender in the auxiliary assembly; and
generating, based on the detected rotational speed, control signals for variably adjusting the spring stiffness and/or damping of the semi-active vibration damper of the mounting of the auxiliary assembly.

15. The control method according to claim 12, further comprising:
detecting ambient noise of the vehicle using of an exterior microphone; and
storing the detected ambient noise in a computer-readable on-board data memory in the form of recorded reference acoustic signals.

16. The control method according to claims 12, further comprising:
receiving noise emission and/or noise immission limit value data from a charging station for the vehicle or based on received GPS data, wherein the noise emission and/or noise immission limit value data relate to the surroundings of the vehicle.

17. The control method according to claim 12, further comprising:
variably detecting particularly variably, the charging power of the electric accumulator of the vehicle during the charging process based on the cooling output of an air conditioning system necessary for cooling the electric accumulator during the charging process, while maintaining noise emission and/or noise immission limit values.

18. The control method according to claim 12, further comprising:
emitting sound in the surroundings of the vehicle using at least one exterior speaker for masking the sound emitted by an auxiliary assembly, wherein the sound is based on recorded reference acoustic signals read-out in chronologically irregular intervals.

19. The control method according to claim 12, further comprising:
prioritizing the generation of the control signals based on a seat occupation of the vehicle, detected using sensors, and/or detected surroundings data of the vehicle.
